(19) United States
(12) Patent Application Publication
(10) Pub. No.: US 2026/0009233 A1
(43) Pub. Date: Jan. 8, 2026

(54) Mounting element for panels and method for fastening panels to a support structure

(71) Applicant: DISSING A/S, Skanderborg (DK)

(72) Inventor: Claus Hornstrup Dissing, Ry (DK)

(73) Assignee: DISSING A/S, Skanderborg (DK)

(21) Appl. No.: 19/112,410

(22) PCT Filed: Sep. 12, 2023
(86) PCT No.: PCT/DK2023/050219

§ 371 Date: Mar. 17, 2025

(30) Foreign Application Priority Data
Sep. 16, 2022 (DK) PA 2022 70451

(51) Int. Cl. E04F 13/08

(52) U.S. Cl. CPC E04F 13/0833

(57) ABSTRACT

A panel (5) with fixation holes (6) is fastened to a support structure by using spacer inserts (1) around screws (7) which extend through the fixation holes (6) and are fixed in the support structure. The spacer insert (1) comprises an inner circular ring (2) with a center passage (4) through which the screw (7) extends. Vanes (5) extend outwards from the ring (2) for abutting the inner rim of the fixation hole (6). The vanes (3) are resilient and allow lateral movement of the panel (5) relatively to the fixed screw (7).

### FIELD OF THE INVENTION

The present invention relates to method for fastening and holding panels, in particular facade panels, on a support structure, such as a wall, and a mounting element comprising a spacer insert for insertion into fixation holes of the panel, in particular according to the preamble of the independent claims.

### BACKGROUND OF THE INVENTION

When facades of buildings are covered with facade panels, it is common practice to fasten the panels by screws to a substructure of metal or wood. Temperature variations causes expansion and contraction of the panels, leading to tension in the material around the fastening points. In particular, fiber cement facade panels are also subject to a significant swelling and shrinking behavior depending on the humidity, which leads to further tension. In worst case, expansion and contraction may result in breakage of the panels. Alu panels and high pressure laminates do not suffer from breakage but have a tendency to bend when expanding, which is also unwanted. Additionally, there is a risk for the panels to slide off the screws.

In order to prevent breakage, the mounting holes through which the corresponding screws are driven for connection to the substructure are formed with a considerably larger diameter as compared to the diameter of the fasteners.

The problem of tension around the mounting area increases if the screw is not properly centered. It is therefore important to center the screw properly in the fixation holes. Such shrinking and expansion behavior and proper centering of the screws must be taken into account when installing the facade panels.

In order to secure that the mounting screws are centered within the oversized holes, inserts are provided in the oversized holes and a screw driven through the insert, which centers the screw in the hole. Examples are disclosed in international patent applications WO2018/171895 and WO2021/004756. However, such insert do not allow for sufficient movements of the panel relatively to the screw, which may create tension around the hole.

In order to allow movement of the panel relatively to the screw, international patent application WO2017/125166 discloses an insert with a disc having the size of the holes in the facade panel and which is inserted into the hole. A collar on one side of the disc rests against the outer surface of the panel at the rim of the hole. The disc has a central opening that centers the screw in the hole when inserted for screwing it into the underlying support structure. Once, the screw is driven through the central portion of the disc, a portion breaks away so that the screw is no longer held in place by the disc, and the panel can move relatively to the centered screw. The head of the screw is wider than the collar and tightens against the collar for preventing dust and other debris to enter the hole from the outer side of the panel. Although, this solution is in many ways practical, it suffers from the drawback that the insert may break before the screw has been screwed into the underlying support structure, which implies the risk that the screw is not properly centered during the typically quick mounting procedure of the facade panels.

European patent application EP1876314 discloses an insert having a plugging section with an outer diameter equal to the diameter of a fastening hole of the facade panel. The insert has a through hole for centering of a screw during mounting and for play-free accommodation of it after mounting. The unit is formed as single piece from an elastic plastic which has vanes that extend radially outwardly from the central screw-accommodating portion to the rim of the through hole. By deformation, the vanes take up relative movements between the facade panel and the fastening unit. A sealing lip is formed at the section for sealing the fastening hole against external moisture. This insert has a disadvantage in that the lip extends to the rim of the hole and hampers movements of the panel relatively to the hole.

WO2013/076494 discloses an insert with a ring to abut the inner rim of the hole and center portion for centering the screw as well as a spring-like arrangement between the center portion and the ring for allowing movements between the panel and the screw. This insert consists of multiple pieces and is rather complex and expensive in manufacture in addition to requiring relatively long time in the mounting process.

For many of the inserts on the market and disclosed in the prior art, there is a further general disadvantage in that they have to be oriented in a specific way. It must be recalled that workers that mount facade panels are often paid according to the number of facade panels mounted, which requires that the mounting should be as quickly as possible. Even minor improvements with respect to speed of mounting is welcome and desired.

A fastening spider for fastening a lining element to a support structure is disclosed in WO2017/008135. The fastening spider is inserted into corresponding linier openings, shaped similarly, thus, filling the openings and restricting movement of the liner relatively to the fastening spider. This type of fastener does not sufficiently fulfil the requirements for panels that expand and contract.

Accordingly, there is still need for improvements. In particular, it would be desirable to provide inserts that is robust, easy to manufacture, reliable in function. It would also be desirable to provide an insert that avoids the need for specific orientation.

### DESCRIPTION/SUMMARY OF THE INVENTION

It is therefore an objective of the invention to provide an improvement in the art and avoid disadvantages of the prior art. In particular, it is an objective to provide an insert for facade panels which centers the screw during mounting, and which allows for movement of the facade plate relatively to the screw after mounting and which avoids time for finding correct orientation. These objectives and further advantages are achieved with a mounting element comprising a spacer insert and a method for fastening a panel to a support structure as described below and in the claims.

In short, a panel with fixation holes is mounted to a support structure by using spacer inserts around screws which extend through the fixation holes and are fixed in the support structure. The spacer insert comprises an inner circular ring with a center passage through which the screw extends. Vanes extend outwards from the ring for abutting the inner rim of the fixation hole. The vanes are resilient and allow lateral movement of the panel relatively to the fastened screw, compensating for expansion and contraction of the panel.

For example, the panel is a facade panel that is fixed to a support structure, which is attached to a wall. Optionally, however, the panel is fixed directly onto the wall.

Further details and advantages are apparent from the following description.

As part of a mounting element, spacer insert are provided for insertion into the fixation holes of the panel. The spacer inserts are dimensioned to fit into the holes, which are oversized relatively to the screw stem and thread. The spacer insert comprises a ring around an open center passage for guiding a screw or nail along a central axis through the center passage when fastening the panel against a support structure by the screw or nail. For example, the center passage has a diameter D1 in the range of 1.6-6.8 mm.

The spacer insert comprises at least three vanes extending from the ring outwards, for example radially outwards, although, typically, more vanes are provided, for example 4, 5, 6, 7, or 8 vanes. Each of the vanes has an end face for abutting an inner rim of the corresponding fixation hole. In particular, each of the vanes is fastened only to the ring. The end faces of the vanes are freestanding for abutting the corresponding fixation hole by the insert spacer only with the end faces of the vanes. This implies that the insert spacer is free from an outer ring between the vanes and the inner rime of the panel holes. Also, the fact that the vanes are freestanding results in greater movability of the panel due to the greater flexibility of the vanes than in prior art systems where the vanes are supported by a disc, such as in EP1876314.

Due to their resilient material, the spacer inserts allow sufficient play of the panel relatively to the position-wise fixed screws in order for the panel not to break during later expansion and contraction, for example caused by temperature changes and/or humidity. For example, the insert spacer is made of a resilient material with a hardness in the range of Shore A 50-100.

It is an advantage of the spacer insert is symmetrical with respect to a plane perpendicular to the central axis through the center passage, as the spacer insert can be inserted into the holes with either of two different orientations, so that effort and time for adjusting the right orientation during mounting are minimized. Due to the symmetry, the insert spacer has two identical faces on opposite sides of the symmetry plane. One of the end faces is facing, and typically abutting, the underlying material when mounted. The opposite face is facing the underside of the screw head. For example, the faces are plane and parallel.

Optionally, the vanes are wedge-shaped, narrowing with distance from the central ring, which makes then more flexible near the edge of the opening in the panel.

In some embodiments, the ends of the vanes around the guiding passage are straight and parallel to a central axis of the ring.

Optionally, the vanes have a length of 0.5-1.4 times the diameter D1 of the center passage when measured perpendicular to the central axis.

Alternatively, the outwards directed, for example radially outwards directed, end face of each vane has two halves, with one half on either of the two opposite sides of the symmetry plane, wherein the two halves of the end face are not parallel but inclined with an angle V relatively to the central axis. This implies that the size of the spacer insert decreases with distance from the symmetry plane, and a diameter of a circumscribed circle at the faces is smaller, for example by at least 0.5 mm, than a diameter D3 of a circumscribed circle at the symmetry plane.

Optionally, the circumscribed circle around the insert spacer, for example in the symmetry plane, has a diameter D3 in the range of 6.0-13 mm. Optionally, the diameter D1 of the center passage is in the range of 0.2-0.5 times D3.

The screws that are used for fixing the panel to the support structure typically have a screw head with a lateral extension larger than the diameter of the fixation holes in order for the panel not to slide over the screw head. It may also cover the vanes and the remaining part of the fixation hole to prevent ingress of dust and other debris.

As an option, the mounting element comprises a self-drilling screw that has a drill tip on which the spacer insert is already mounted prior to locating the screw at the fixation hole. Such prior fixing of the spacer insert onto the drill tip can be done automatically by machines, especially when the spacer insert is symmetrical. This combination of screw and spacer insert eases the mounting procedure, as the worker does not have to first fix the spacer insert in the fixation hole of the panel and only then insert the screw. Instead, the drill tip already extends through the center passage of the ring of the spacer insert, and the combination of screw and spacer insert is then moves to the fixation hole and inserted. In order to hold the spacer insert fixedly on the drill tip, the drill tip has a diameter D8 that is slightly larger, for example 0.2-0.5 mm larger, than the inner diameter D1 of the center passage. This way, the spacer insert is fixed on the drill tip by resilient expansion of the ring around the drill tip.

Optionally, the insert spacer has a height H of 3.0-9.0 mm when measured parallel to the central axis.

Although, the invention is particularly useful for facade panels, it can also be used for other types of panels fastened to a support structure, for example a support structure of metal or wood, for example a frame.

For facade panels the following mounting procedure is useful. In order for not the entire panel being movable, it is advantageous to fasten a central part of the panel non-movably to the support structure. For this case, the panel is provided with fixation holes in edge regions of the panel and with a central hole in a central part of the panel. The panel is then firstly fastened to the support structure, with a screw through the central hole, typically by using a screw-centering bushing in the central hole. Position-wise, this fixes the central part of the panel non-movably to the wall. The bushing is different from the spacer inserts in that it prevents the panel from moving laterally, for example laterally relatively to a wall. Once, the central part of the panel is fixed, further screws are driven through the spacer inserts in the fixation holes in the edge regions, for example corner regions. As the spacer inserts at the edge parts of the panel are resilient, they allow lateral floating movement of the edge parts of the panel relatively to the position-wise fixed screws or nails in the edge parts and relatively to the fixed central part of the panel.

### SHORT DESCRIPTION OF THE DRAWINGS

The invention will be explained in more detail with reference to the drawing, were

FIG. 1 illustrates a spacer insert in a head-on view;

FIG. 2 shows a spacer insert inside a mounting hole of a panel;

FIG. 3 illustrates parameters of spacer insert;

FIG. 4 shows a combination of a spacer insert and a screw;

FIG. 5 illustrates a tapering spacer insert in perspective view;

FIG. 6 illustrates a tapering spacer insert in side view.

### DETAILED DESCRIPTION/PREFERRED EMBODIMENT

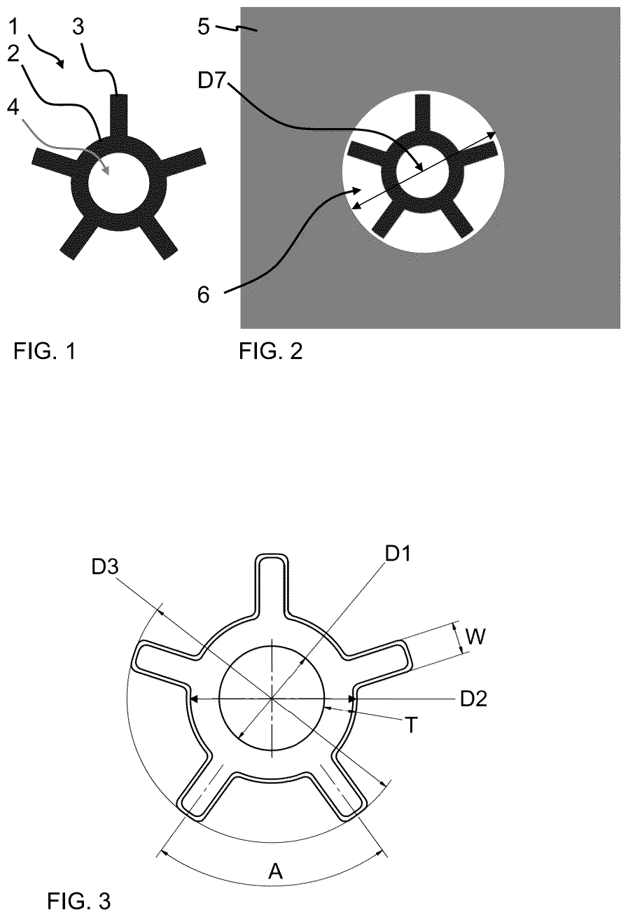

FIG. 1 illustrates a spacer insert 1 that consists of a ring 2 which has a center passage 4 and which on its outer ring surface along the circumference has a five equally long outward extending vanes 3.

At least three equally long outward extending vanes 3 are necessary for proper centering of the spacer insert 1 in the fixation holes of a panel, but typically more than three vanes are used for stability. On the other hand, the number of vanes is typically no more than fifteen, and often no more than ten.

FIG. 2 illustrates a portion of a panel 5 around a fixation hole 6 for mounting on a support structure, for example made of wood or metal. For example, the support structure forms an underlying material between the panel 2 and a wall, although, this is not always strictly necessary, and the panel can also be mounted directly to a wall in some cases. In this case, the wall forms the support structure.

In general, such a panel 5 has multiple fixation holes 6 for mounting the panel 5 to the support structure. The fixation holes 6 have a diameter D7, as indicated. As discussed above, temperature variations and humidity may cause expansion and contraction of the panel 5. If not compensated for, this expansion or contraction would lead to tension and potential damage in the panel 5 or the screw 7. For the compensation, spacer inserts 1 of special character are provided, which are inserted into the fixation holes 6, which are also oversized relatively to the fastening screws that are used in the fixation holes 6 for holding the panel 5 onto a wall. The vanes 3 are resilient so that the panel 5 through deformation of the vanes 3 can move relatively to the fixed screw in the center of the insert spacer 1. The vanes 3 of the insert spacer 1 are advantageously abutting the rim of the hole 6 in order not to fall out again once fixed therein by insertion into the hole 6.

FIG. 3 illustrates an example of a design and parameters of a spacer insert 1 in top-view. The center passage 4 has a diameter D1, which is the inner diameter of the ring 2. The ring 2 has an outer diameter D2 and ring thickness T, as illustrated. The vanes 3 that extend from the ring 2 outwards, typically radially outwards, have a length L. With the radially outward directed vanes 3, the diameter D3 of a circumscribed circle around the insert spacer 1 is D3=D2+2L=D1+2T+2L.

In case that the extension D3 of the insert spacer 1 is larger than the diameter D7 of the fixation hole, the insert spacer 1 has to be pressed into the opening 6 of the panel 5 and will get fixed there, which is an advantage for the mounting, as the screw is then easily inserted through the center passage 4 with the correctly centered position.

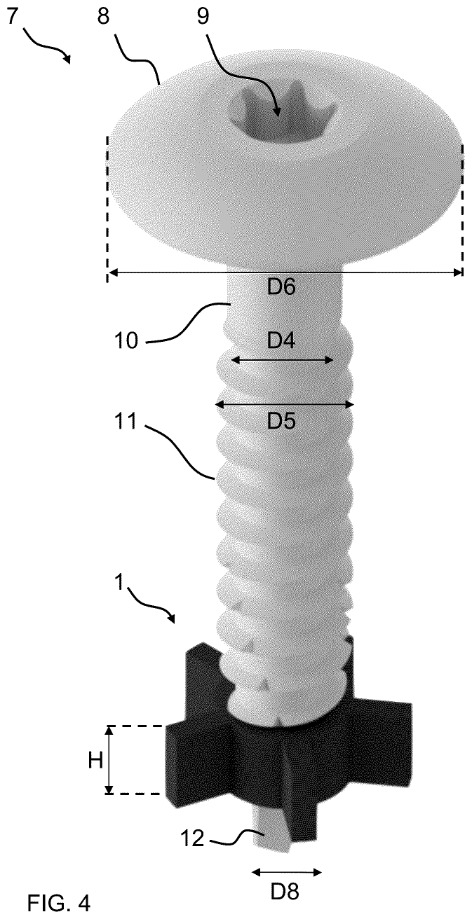

FIG. 4 illustrates a combination of a spacer insert 1 and a screw 7. The drill tip 12 of the screw 7 is extending through the center passage 4 of the spacer insert 1. The screw 7 comprises a screw head 8 with a tool connector 9, for example, as illustrated, a Torx® connector, for screwing of the screw 7 by a corresponding tool, typically an electrical screwing machine. The screw 7 also comprises a stem 10 with a thread 11 extending to the drill tip 12.

During mounting, the drill tip 12 is held centered inside the center passage 4, which, in turn, by the vanes 3 is held centered inside the fixation hole 6 of the panel 5, so that the screw 7 is centered relatively to the rim of the fixation hole 6. The drilling of the drill tip into the underlying material by rotation of the screw 7 creates a hole passage into the underlying material, where the hole passage is centered relatively to the spacer insert 1 and, thus, centered relatively to the existing hole 6 in the panel 5. The threading 11 of the screw 7 follows into the pre-drilled hole. Once, the screw drill tip 12 is entering the underlying material, the threading 11 will press the insert spacer 1 against the underlying material, making sure that the insert spacer 1 is not sliding out of the existing hole 6 in the panel 5 during the drilling and screwing action, thus, maintaining the screw in centered position until the screw has entered the underlying material sufficiently for stability. After having entered the underlying material with the front end of the drill tip 12, further advance of the screw 7 into the underlying material results in the thread 11 also cutting its way through the center passage 4 of the spacer insert 1.

In some mounting procedures, the spacer insert is fixed in the hole first, and then the screw is inserted through the center passage. However, it is also possible to combine the insert spacer with a screw first and then insert the spacer together with the screw tip into the fixation hole.

For example, the spacer insert 1 has a center passage 4 with a diameter D1 smaller than the diameter D8 of the drill tip. In this case, the spacer insert 1 can be pressed onto the drill tip prior to mounting of the combination of screw and spacer insert 1 into the fixation hole 6. The mounting of the spacer insert 1 onto the drill tip 12 can be done automatically by machines, for example as part of production of the mounting element.

The thread 11 has an inner diameter D4 and an outer diameter D5. As an example, the inner diameter D1 of the center passage 4 of the spacer insert 1 is less than D5, optionally between D4 and D5, thus, D4<D1<D5.

The screw head 8 has a diameter D6. In order to cover the hole 6 in the panel 5, it is advantageous that the diameter D6 of the screw head 8 is larger than the diameter D7 of the hole 6 in the panel 5.

The vanes 3 are resilient and soft enough for allowing sufficient lateral movement of the panel 5 relatively to the ring 2 and, thus, the screw 7, which is fixed in the underlying material. For example, the hardness of the resilient material of insert spacer is in the range of Shore A 50-Shore A 100.

Typically, the vanes 3 are placed with equidistant angles around the ring 4, as indicated in FIG. 3, where the angular span A between center points of the vanes 3 is 360 degrees divided by the number of vanes, which results in 72 degrees for 5 vanes.

For example, the angular span of the vanes 3 themselves with thickness W is less than the angular span A between center points of the vanes 3, for example in the range of 10%-25%

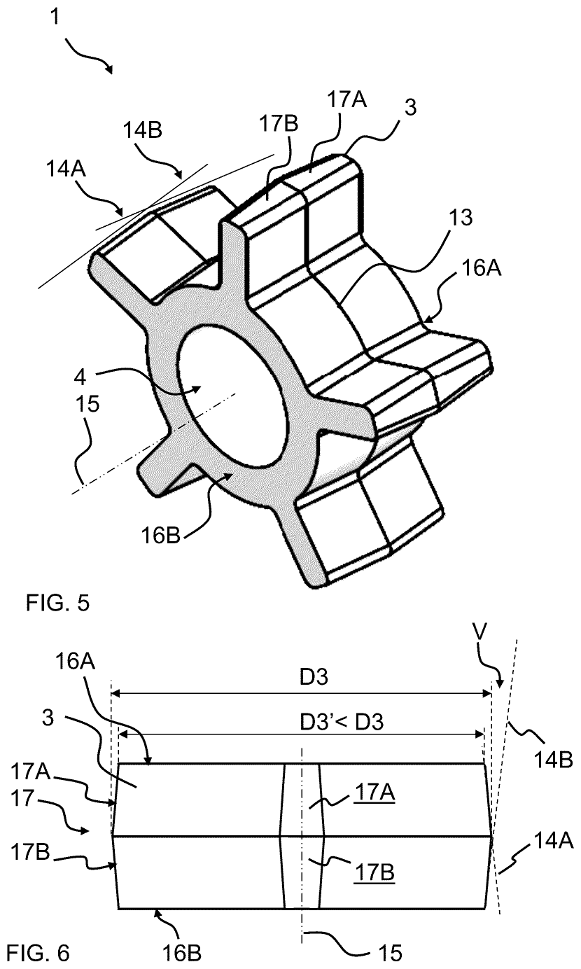

FIG. 5 and FIG. 6 illustrate correspondingly in perspective and side view an insert spacer 1 in which the vanes 3 have an end face 17 with two halves 17A, 17B, which are not parallel with the central axis 15 of the center passage 4 but which are tapered by an angle V towards the two opposite sides 16A, 16B relatively to a central symmetry plane 13 that is perpendicular to the central axis 15 of the center passage 4. The tapering of the two halves 17A, 17B is illustrated by the two lines 14A, 14B, which are not parallel but cross each other at the central symmetry plane 13. As illustrated in detail in FIG. 6, this implies that the diameter D3′ of a circumscribed circle at the sides 16A, 16B of the insert spacer 1 is smaller than the diameter D3 of the circumscribed circle in the central symmetry plane 13. This quasi-double-conical design makes insertion into the fixation holes 6 of the panel 5 easier if the diameter D3′ of the circumscribed circle at the sides 16A, 16B is smaller than the diameter D7 of the fixation holes 6 in the panel 5. For example, D3′=k·D7, where k is in the range of 0.90-0.99. On the other hand, if the circumscribed circle D3 at the central symmetry plane 13 is larger than the diameter D7 of the fixation holes 6 in the panel 5, the insert spacer is held in place inside the hole 6 of the panel 5 after insertion because the insertion into the hole 6 leads to a plastic resilient deformation of the vanes 3. For example, D3=K·D7, where K is in the range of 1.01-1.10.

For the dimensions given in the drawings, the following parameter ranges are advantageous:

Number of vanes: 3-15

D1 Diameter of center passage 4:1.6-6.8 mm (ex. 0.2-0.5 times D3)

D2 Outer diameter of ring 2:

D3, D3′ Diameter of circumscribed circle around insert spacer 1: D3≈D7

D4 Inner diameter of screw thread 11:1.9-5.0 mm

D5 Outer diameter of screw thread 11:3.0-6.5 mm

D6 Diameter of screw head 8:7.5-25 mm

D7 Panel hole 6 diameter 6.0-13 mm (D7≈D3)

D8 Diameter of screw drill point 12:1.9-6.5 mm (ex. D8=D1+0.3 mm)

H Height of insert spacer 1:3.0-9.0 mm

L Length of the vanes 3:0.5-1.4 times D1

T thickness of ring 2:0.4-3.0 mm

V Angle if inclination of vane 4 end face halves 17A, 17B: 0-10 degrees

W width of vanes 4:0.4-3.0 mm

Hardness of resilient material of insert spacer: Shore A 50-100

Optionally, the vanes are wedge-shaped with radially outward decreasing width W

Thickness of panel 6:3.0-18 mm

1. Mounting element for mounting a panel (5) with fixation holes (6) onto an underlying support structure, the mounting element comprises a spacer insert (1) for insertion into the fixation hole (6) of the panel (5), wherein the spacer insert (1) comprises a ring (2) around an open center passage (4) for guiding a screw (7) or nail along a central axis (15) through the center passage (4) when fastening the panel (2) against a support structure by the screw (7) or nail, wherein the spacer insert (1) comprises at least three vanes (3) extending from the ring (4) outwards and each of the vanes (3) having an end face (17) for abutting an inner rim of the corresponding fixation hole (6), wherein the vanes (3) are resilient for allowing lateral movement of the panel (5) relatively to the fastened screw (7) or nail extending through the center passage (4); wherein each of the vanes (3) is fastened only to the ring (2) and that the end face (17) of each of the vanes (3) is freestanding, wherein the spacer insert (1) is configured for abutting the corresponding fixation hole (6) only with the end faces (17) of the vanes (3).

2. A mounting element according to claim 1, wherein the spacer insert (1) is symmetrical relatively to a symmetry plane (13) that is perpendicular to the central axis (15) through the center passage (4) and has two identical faces (16A, 16B) on opposite sides of the symmetry plane (13) for one of the faces (16A, 16B) abutting the underlying material.

3. A mounting element according to claim 2, wherein the faces (16A, 16B) are plane and parallel.

4. A mounting element according to claim 2, wherein the end face (17) of the vane (3) has two halves (17A, 17B) on opposite sides of the symmetry plane (13), wherein the two halves (17A, 17B) are not parallel but inclined with an angle (V) relatively to the central axis (15), wherein a diameter (D3′) of a circumscribed circle at the faces (16A, 16B) is smaller by at least 0.5 mm than a diameter (D3) of a circumscribed circle at the symmetry plane (13).

5. A mounting element according to claim 1, wherein the vanes (3) extend from the ring (4) outwards in radial directions.

6. A mounting element according to claim 1, further comprising a self-drilling screw (7) that has a drill tip (12) on which the spacer insert (1) is mounted, while in a state prior to insertion into the fixation hole, wherein the drill tip (12) extends through the center passage (4) of the ring (2) of the spacer insert (1), wherein the drill tip (12) has a diameter (D8) that is 0.2-0.5 mm larger than a diameter D1 of the center passage (4) and the spacer insert (1) is fixed on the drill tip (12) by resilient expansion of the ring (2) around the drill tip (12).

7. A mounting element according claim 1, wherein
the center passage (4) has a diameter D1 in the range of 1.6-6.8 mm
a circumscribed circle around the insert spacer (1) has a Diameter D3 in the range of 6.0-13 mm
D1 is in the range of 0.2-0.5 times D3
the insert spacer (1) has a height (H) of 3.0-9.0 mm when measured parallel to the central axis (15);
each of the vanes (3) has a length of 0.5-1.4 times D1 when measured perpendicular to the central axis (15);
the insert spacer (1) is made of a resilient material with a hardness in the range of Shore A 50-100.

8. Method of fastening a panel (5) to an underlying support structure, the method comprising providing the panel (5) with multiple fixation holes (6) and providing multiple mounting elements according to any preceding claim, each mounting element comprising the spacer insert (1) and a screw (7), wherein the fixation holes (6) of the panel (5) have a diameter D7 larger than a diameter of a stem (10) of the screw (7), wherein the method comprises inserting the spacer inserts (1) into a fixation hole (6) and fixing the panel (5) to the support structure by the screw (7) extending through the center passage (4) of the spacer insert (1), wherein the method further comprises by resilient deformation of the spacer insert (1) compensating for movement of the panel (5) relatively to the screw (7).
